(19) United States
(12) Patent Application Publication
(10) Pub. No.: US 2018/0162483 A1
(43) Pub. Date: Jun. 14, 2018

(54) Bicycle with Spring

(71) Applicant: Juan Diego Lara, Guatemala City (GT)

(72) Inventor: Juan Diego Lara, Guatemala City (GT)

(21) Appl. No.: 15/579,342

(22) PCT Filed: Jun. 5, 2015
(86) PCT No.: PCT/IB2015/054278

§ 371 Date: Dec. 4, 2017

(51) Int. Cl. B62M 1/10; B62K 23/06; B62M 6/00

(52) U.S. Cl. CPC B62M 1/10; B62M 6/00; B62K 23/06

(57) ABSTRACT

The purpose of the device storing elastic potential energy in a vehicle is making the use of energy to move it more efficient as the device can store excess energy and provide energy when needed. This will make energy storage in a spring for later use possible when riding at high speed and then braking, not to waste energy in friction brakes, in contrast to what regularly happens; in this way, the use of energy will be more efficient. When the cyclist is tired, is riding up a steep slope, or simply needs energy, he will be able to release energy and thus accelerate to improve energy performance. Likewise, the bicycle user will be able to ride farther, ascend to higher peaks, and use less energy for a journey. This will provide people the opportunity to shift to the use of this vehicle instead of a motor vehicle.

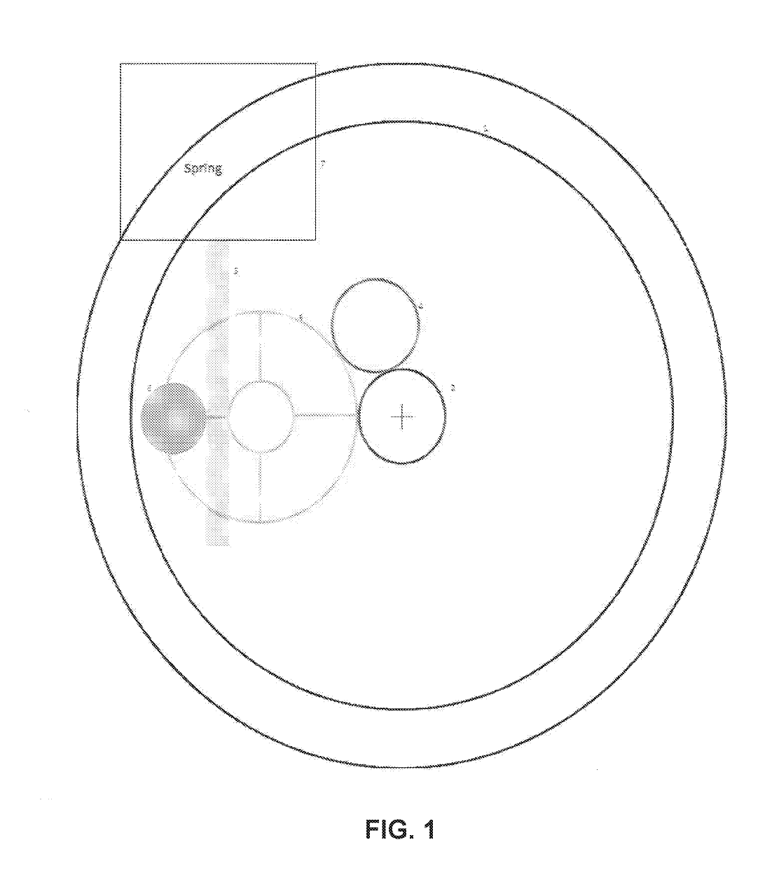

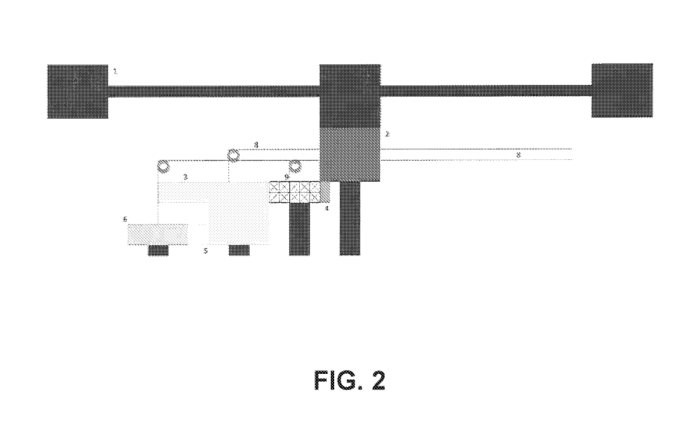

### 2.1) BACKGROUND (SIMILAR INVENTIONS)

1) Flywheel Bicycle

A flywheel bicycle is a bicycle that works with the same braking energy storage principle as a flywheel, which stores the kinetic energy from the bicycle moving with kinetic energy in the flywheel. This is a wheel in the bicycle merely storing energy. That patent differs from this in that this one uses a spring and has the advantages that the energy can be stored indefinitely, it weighs less, and flywheel inertia does not interfere with the ride.

2) Bicycle with Generator and Battery

This system has the same function as the device and is based on an electric generator that is activated when braking. Power is stored in a battery and drives an engine to accelerate. That patent differs from this in that this one does not have an engine, generator, and battery mechanism, thus making the system lighter and cheaper and keeping the concept of a bicycle.

3) Bicycle with Rotating Spring

This patent involves a rotating spring in a bicycle to store energy; the problem is that when accelerating or braking, the inertia moving the spring limits bicycle speed. Moreover, the capacity of a rotating spring is lower than that of a tension or compression spring, the rotating spring wears out with time, and the cost tends to be higher.

4) Bicycle with Dynamo

The dynamo functions as a generator, engine, and battery working as in patent 2) of this list. However, that patent is smaller and its design and characteristics are different. That patent differs from this in that this one uses no electrical system and has the advantages of a higher capacity and a lower cost, although this patent has the disadvantage of less favorable visual aesthetics of the system.

5) Springs in Bicycles for Comfort

Those springs applied to bicycles have nothing to do with this patent as those springs are used for saddle comfort and as suspension in the bicycle to increase comfort. They are very good to increase comfort but have nothing to do with the energy system of the bicycle, although they could be added to it as an extra device.

### HISTORICAL OVERVIEW

The bicycle with spring consists in a novel application of a device providing energy to vehicles with two or more wheels. It involves an addition, e.g., a spring, that, when installed in vehicles, provides the user control to employ elastic potential energy stored when needed. The purpose of the device is to give the user control in terms of the energy existing in the system, whether kinetic (MOTION) or potential (STORED WITH POSSIBILITY OF USE), for instance, when the average user wants a high amount of kinetic energy when riding, as the device provides a boost and speed, while, when still, he wants to have energy stored to continue afterward.

The idea of this invention came up due to the use of a bicycle as a means of transportation. When going through some terrain, especially a slope or ascent, the thought of creating a device to make the use of the necessary energy for the ride more efficient came to my mind. On the way up, the cyclist certainly needs more energy from himself to offset gravity, while, on the way down, he use less energy as gravity helps him. The purpose of this invention is to provide the user control in terms of when to make the necessary energy transformations for the ride.

This is helpful to the user as excess kinetic energy during speed reduction can be stored for later use, for instance, when accelerating. As a result, the energy the user requires during a ride is more efficient as, when reducing speed (BRAKING), energy is not wasted, in contrast to what currently happens, but is stored in this device for later use, thus making a reduction of the necessary energy for the ride possible.

The speed reduction system consists in a system of gears and rack whose function is to transmit potential energy stored in the spring; this energy is transferred to the rear bicycle wheel through the rack and gears. The transfers begin from the two levers at each side of the front controls. One of the controls releases potential energy from the string to transmit it to the wheels as motion energy. Meanwhile, the other control transfers motion energy into potential form, and, as a result, speed decreases, as energy is not created or destroyed but merely transformed.

One of the advantages of this system is that the energy from speed reduction is not lost in friction, in contrast to what currently happens. Instead, energy is stored for later use when required. Thus bicycle performance improves and the user is able to reach greater distances and speed, as well as height, and ascend to higher or tougher peaks with less effort by using the power of system energy efficiency.

The system innovation consists in the capacity of transferring kinetic energy from the bicycle into potential energy in a string or fluid compression for it to be used later in order to make the use of energy during a bicycle ride efficient. The form of energy storage may be a spring or fluid compression. Moreover, a calibrator o lock is used to retain, sector, and store energy, although this storage mechanism varies.

### 2.2) DEVICE DESCRIPTION

One of the main applications of the device providing energy to vehicles with two or more wheels would be a bicycle to which a spring with tensioning or compressing functions has been added. The result is energy storage for later use. In other words, kinetic energy from bicycle speed becomes potential energy stored in the spring. The spring could obtain energy when the bicycle user reduces speed, and, by that means, activates the gear system, which transfers energy from speed to the spring in an elastic potential state through the gears and rack, which makes direct contact with the spring and indirect contact with the gears. It is indirect as only when the system is activated the rack makes contact with some spring.

The system is mainly based on the rear bicycle wheel; it consists in central axle (A), which is directly connected to the wheel, which means that, by direct connection, the central axle generates exactly the same revolutions as the tire. This central axle will make contact with secondary gear wheel (B), whose dimensions will differ from those of the central axle as it will alter force magnitude. This gear B wheel has in its center smaller wheel (C), fully welded to it. This smaller wheel is directly connected to the rack regulating the position of the spring, which stores potential energy from the bicycle.

The central axle rotates freely, but, when the cyclist wants to reduce speed, he pulls a lever, which makes secondary gear (B) come into contact with the central axle. Thus central axle (A) comes into contact with secondary axle (B), which is connected to smaller wheel (C). Therefore, when pulling the lever, energy from speed coming from the wheel is immediately directed toward the spring, which stores such energy. In this process, when compressing or stretching the spring, the energy that was in motion is transferred to the spring for later use.

Later, when the user wants to increase speed, he pulls the other lever. Instead of gear (B), another gear, called gear wheel (D), is activated. The function of this gear, which is in contact with gear (B) at all times but is in contact with central axle (A) only when activated, is to change force direction, thus increasing speed instead of reducing it. As a result, the bicycle is accelerated forward. This is possible as, when the spring releases energy, rather than storing it, the spring compresses or stretches to the other side. This compression or tension makes gear (B) change direction; however, as a cyclist regularly wants to go forward, this gear wheel (D) changes the direction in which force heads, thus making it possible for central axle (A) to go always forward.

Therefore, the system consists in a central axle that can be in contact with two gears that are activated as if by orders by the user of the bicycle with the device. When activated, they move to be in contact with central axle (A) to make the energy transfer. But only smaller wheel (C) is in contact with the rack moving the spring. The bicycle acceleration or braking levers are located on the bicycle handlebars, and their function is to accelerate or brake. To make this possible, the brake lever pushes gear (B) for it to be in contact with central axle (A) and thus brake.

The other acceleration lever pushes gear (D) for it to be in contact with gear (B) and the central axle. This function also releases a small portion of spring force. This is possible thanks to lock (E), which retains energy from the spring; it lets energy in but not out. When the user wants to release energy, he pushes the acceleration lever, which, in turn, pushes gear wheel (D) and, at the same time, releases a portion of energy regulated by the amount of time the user keeps the lever pushed. When the user stops pushing the lever, lock (E), as well as the gears, returns to continue the regular bicycle ride.

Gears move directly when the bicycle user pulls one of the levers as one lever is intended to move gear (B), while the other one is intended to move gear (D). When the cyclist pulls a cable lever, a small spring is activated; this is moved by the force generated to push the levers. In the case that the spring is at full capacity, a conventional friction brake (F) will be activated. This is located at the end of the rack. If it is fully compressed or stretched, the rack end gets closer to the tire when pressing the brake, which is the one transferring energy to the rack, thus moving it; it will finally be obstructed by the tire, and, as there is friction (F) at the end, the bicycle will simply stop. If the user employs all the energy from the spring, acceleration will simply not be possible, but braking is vital as a safety measure.

The bicycle works just as a conventional bicycle, except for the gear system, which can be added to a conventional bicycle simply by mounting the central axle (A) system on the rear bicycle wheel center and implementing the two levers on the handlebars, at the point chosen by the manufacturer, customer, or designer. Both preexisting levers will usually be changed to leave only two: one to accelerate and one to brake. In this way, the user will be safer.

The bicycle pedals, chain, and shifters will remain in the same place and work in the same way, and this device will be mounted on the other side of the wheel, in the case of a preexisting bicycle. In the case of a bicycle whose manufacture includes this device, the bicycle may be equipped with two (one on each side) for aesthetic and statics-related purposes; they will not weigh much, and the bicycle will still be stable. The device design, location, and capacity will be a manufacturer's or customer's decision, as long as central axle (A) can be in contact with the rear wheel center. The bicycle design, capacity, price, and performance, as well as material and size, will be a manufacturer's or customer's decision; in this way, the manufacturer will enjoy product flexibility.

### 3) DRAWINGS

Drawing Legends

1.-19. (canceled)

20. A bicycle with spring, comprising a mechanism which allows for the conversion of the bicycle's kinetic energy to elastic potential energy, effecting a decrease of speed and serving as replacement to a brake, either by tension spring, compression spring or some fluid such as a piston, wherein energy generated at the time of braking is stored in order to be able to use it later to move forward, further wherein a central shaft rotates at the same radial velocity as the bike attached to it, and still further wherein two gears come into contact to brake or accelerate the bicycle.

21. The bicycle with spring of claim 20, wherein the central shaft is attached to one of the bicycle's tire or to any vehicle in particular, further consisting of three wheels of gears; the Central (A) that is tied Center-to-Center with a rim, the gear (B) to a side that has a Center (C) which has contact with a rack that feeds to a spring and a gear (D) which changes direction the outgoing or incoming spring force, depending on manufacturer's specification.

22. A bicycle with spring, comprising a central shaft which may have contact with two gears that are activated as orders that are used when you move, with the purpose of having contact with the central axis, but only gear A is in contact with the rack, gear A thereby, when enabled, comes in contact with the central shaft and also with the rack, so as to carry out better power transmission, Gear B being adapted to change the direction of the force, since the bicycle is always going forward but the spring has directions in which to store or release energy.

23. The bicycle with spring of claim 22, wherein the gears move directly when the bicycle user is pulling one of the levers, because one of the levers would serve the purpose of moving gears, more specifically, as the pilot pulls the lever, a cable would activate a small spring and the gear would move enough so as to come in contact with the central shaft and perform its procedure.

24. The bicycle with spring of claim 20, wherein the dock where the tension spring or compression sits is in an arbitrary location but the most common would be vertically above the central axis of the bike, the central axis being in an arbitrary position but in contact with the transmission gear and in contact with the rack, wherein the gear arrangement in profile or front view varies in position so as not to have contact with the central axis, and further wherein when the mechanism is activated either gear B or C comes into contact to activate the mechanism.

25. The bicycle with spring of claim 20, further including a secondary axis parallel to the central axis for such transmission of energy; making it a system that can change the sizes of the pulleys and that has a cone type structure in the transmission of this energy in both directions.

26. A device for retrofitting a vehicle, such as a bicycle, to store energy in a potential form which comes from the decrease in its speed, making a conversion from kinetic energy movement to potential energy, comprising a spring or potential energy storing device whether in tension, compression, or fluid compression, wherein the spring is connected to a central axis of the vehicle and being able to brake or accelerate it through the connection, the device further having two additional axes, the B-axis which has direct contact with the rack and the C-axis, which is used to change direction.

27. The bicycle with spring of claim 20, wherein the device is adaptable or manufactured with the vehicle, which can have numerous springs in many parts of the vehicle in order to maximize the capacity of the system but having the basic functionality of regulating energy in the system by the user.

28. The bicycle with spring of claim 20, further including an indicator; which tells the user to what length are the springs stretched for purpose of transmitting information, which operates as a meter of energy within the spring and is shown as a speedometer, display or in any way the customer or manufacturer decides.

29. The bicycle with spring of claim 22, further including a friction brake located on the bottom of the rack with the purpose of having the bicycle come to a halt when the spring capacity has already been exceeded, as safety feature so that it can always slow down at all times.

30. Locking system which lets the spring absorb more energy but it does not let to come out unless the mechanism is activated upon pulling one of the levers which lets certain amount of energy come out. This system can also be applied in some the compression of fluid with a rack except so that instead of a spring there is a compressor of some sort of fluid. The system may later have an added parallel system to manage the stored potential energy which lies managing the rack. The location of the system may vary, provided the function is not being altered.

31. The bicycle of claim 22, so as not to release the spring, further having a sprocket for strength on the other side of gear C in order to give stability to the rack, this sprocket can only go in one direction which is to compress the spring, and further when acceleration is desired, this sprocket is deactivated and part of the spring energy is released to accelerate the bicycle.

32. The bicycle of claim 20, wherein the center axis can transfer its movement elsewhere by means of a belt or chain, for reasons of aesthetics and functionality, and further wherein the system can also be reversible using, for example, a tension spring.
